(19) United States
(12) Patent Application Publication
(10) Pub. No.: US 2022/0010734 A1
(43) Pub. Date: Jan. 13, 2022

(54) MECHANICAL DRIVE SYSTEM AND ASSOCIATED MOTOR COMPRESSOR

(71) Applicant: GE ENERGY POWER CONVERSION TECHNOLOGY LIMITED, Warwickshire (GB)

(72) Inventors: Christophe Galmiche, Toul (FR); Lionel Durantay, Champigneulles (FR)

(73) Assignee: GE ENERGY POWER CONVERSION TECHNOLOGY LIMITED, WARWICKSHIRE (GB)

(21) Appl. No.: 16/923,266

(22) Filed: Jul. 8, 2020

(51) Int. Cl. F02C 7/36; H02K 1/27; H02K 7/00

(52) U.S. Cl. CPC F02C 7/36; F05D 2220/76; H02K 7/003; H02K 1/27

(57) ABSTRACT

This mechanical system for rotating electric machine comprises at least one rotor and at least one transmission shaft for mechanical device. The rotor has a non-through shaft and comprises a cylindrical magnetic block enclosed between a first and a second raised compaction elements forming a rotor shaft, with one end of the transmission shaft being connected directly to the first compaction element.

### FIELD OF THE INVENTION

The present invention relates to mechanical drive systems comprising at least one rotor without through shaft connected to a transmission shaft.

The present invention also relates to a motor compressor comprising such a drive system.

### BACKGROUND

FIG. 1 illustrates an example of motor compressor 1 comprising a mechanical drive system according to the state of the art comprising a rotating electric machine 2 connected to a compression section 3 via a flexible coupling device 4.

The flexible coupling device 4 comprises two coupling flanges 4a and 4b connected by a shaft 4c. The flanges 4a and 4b are fitted with a flexible lining 4d.

The rotating electric machine 2 comprises a stator 5 in which is inserted a rotor 6 with shaft 6a through the magnetic sheets 6b and connected to the flange 4a.

The compression section 3 comprises compression wheels 5 mounted on a shaft 7 of section 3.

The shaft 7 of section 3 is connected to the coupling flange 4b.

Bearings 8 and 9 maintain the rotor shaft 6a of the electric machine 2 in rotation and bearings 10 and 11 maintain the shaft 7a of section 3 in rotation.

The flexible coupling device enables the own modes of the rotor shafts 6a and shaft 7 of compression section 3 to be separated.

Reference may also be made to documents U.S. Pat. Nos. 7,144,226, 8,137,081, 3,874,823, GB282113 and GB1068004 which disclose a motor compressor comprising the flexible coupling device which connects a rotating electric machine with a compression section.

However, the flexible coupling device 4 increases the weight of the transmission line comprising the rotor shaft 6a, the flexible device 4 and the shaft 7 and increases the length L according to a rotation axis A of the motor compressor 1.

In addition, bearings 9 and 10 are dimensioned to support the weight of the device 4, increasing by as much the weight and length of the motor compressor 1.

The flexible coupling device 4 also dissipates the thermal energy, degrading the overall performance of the motor compressor 1.

In addition, if the rotating electric machine comprises a rotor with through shaft, the peripheral speed of the rotor is limited to 200 m/s in order to limit the concentration of constraints in the magnetic sheets 6b generated under the effect of the centrifugal force and likely to damage the rotor. This limitation of the rotational speed degrades the motor compressor's performance.

Reference may also be made to documents WO2015/153081, US2012/0164005, EP1392981, EP1074746 and US2002/0037772 which disclose a motor compressor comprising a rotating electric machine comprising a through-shaft or one-piece rotor connected directly to a shaft of a compression section.

As the rotor is one-piece, it does not have a through shaft. Consequently, the rotor's rotation speed is not limited. The direct connection between the rotating electric machine and the compression section enables a bearing to be removed, for example bearing 10 shown in FIG. 1 and the flexible coupling device 4 shown in FIG. 1.

The one-piece rotor comprises a squirrel cage made for example from copper and inserted directly into the rotor made for example from carbon steel.

Consequently, the currents induced in the squirrel cage circulate in the carbon steel rotor, causing the rotor to heat up (“iron losses”) degrading the rotating machine's performance.

It is therefore proposed to overcome all or part of the disadvantages of the mechanical systems according to the state of the art, in particular by reducing the weight and the dimensions of said systems, by increasing the rotational speed of the rotating electric machine incorporated in said systems and by increasing the overall performance and the power of said systems.

### SUMMARY

On the basis of the foregoing, a mechanical system for rotating electric machine comprising at least one rotor and at least one transmission shaft for mechanical device is proposed.

The rotor has a non-through shaft and comprises a cylindrical magnetic block enclosed between a first and a second raised compaction elements forming a rotor shaft, with one end of the transmission shaft connected directly to the first compaction element.

According to one characteristic, the mechanical system also comprises a second transmission shaft for mechanical device, with the second transmission shaft connected directly to the second compaction element.

According to another characteristic, the mechanical system further comprises a second rotor with non-through shaft, with the second compaction element of the second rotor being connected directly to a second end of the transmission shaft.

Preferably, the first and second compaction elements have an identical structure.

Advantageously, the first or the second compaction element comprises a fixing flange in contact with the magnetic block and integral with the first or second transmission shaft.

According to one characteristic, the first or second compaction element comprises a fixing flange in contact with the magnetic block, with the free end of the first or second compaction element comprising a coupling sleeve and the first or second shaft slotting into the coupling sleeve so that a mechanical torque transits through one of the transmission shafts and the fixing flange.

Preferably, one end of the first or second transmission shaft comprises a first coupling flange, with the first or second compaction element comprising a fixing flange in contact with the magnetic block, the free end of the first or second compaction element comprising a second coupling flange connected to the coupling flange of the first or second transmission shaft so that a mechanical torque transits through one of the transmission shafts and the fixing flange.

According to one characteristic, the mechanical system also comprises a median shaft connecting the fixing flange and the second coupling flange.

Advantageously, the mechanical system further comprises screws, with each screw passing through an open smooth hole in the first coupling flange and held in a threaded hole in the second coupling flange, with the threaded holes distributed uniformly over an implantation diameter in the second flange and the open smooth holes distributed uniformly over an implantation diameter in the first flange, the implantation diameters of the holes in the first and second flanges being equal or substantially equal.

Preferably, the mechanical system further comprises tie rods distributed uniformly over a diameter of the magnetic block so as to maintain the magnetic block compacted between the two compaction elements, with the end of the tie rods in the first or second compaction element being sunk in the said compaction element, the implantation diameter of the tie rods being lower than the implantation diameters of the first and second flanges.

According to one characteristic, the mechanical system also comprises tie rods distributed uniformly over a diameter of the magnetic block so as to maintain the magnetic block compacted between the two compaction elements, with the end of the tie rods in the first or second compaction element sunk in the said compaction element, the implantation diameter of the tie rods being equal or substantially equal to the implantation diameters of the first and second flanges, the threaded holes alternating with the implantation holes of the tie rods.

According to yet another characteristic, the first flange comprises a central blind hole and the second flange comprises a central pin which slots into the blind hole to transmit a torque between the first and second flanges.

Advantageously, the first and second flanges comprise blind holes distributed uniformly over the same diameter, with the system also comprising pins inserted into the blind holes in the first and second flanges to transmit a torque between the first and second flanges.

Preferably, the first or second compaction element comprises a fixing flange in contact with the magnetic block, with the free end of the first or second compaction element comprising a central through hole, with one end of the first or second transmission shaft slotting into the through hole so that a mechanical torque transits through one of the shafts and the fixing flange.

According to another aspect, a motor compressor is proposed comprising a mechanical drive system as defined previously, the same number of rotating electric machines as rotors and the same number of mechanical devices as transmission shafts, with each rotor inserted into a different electric machine and each transmission shaft connected to a different mechanical device comprising a compression section.

Other characteristics and advantages of the invention will emerge on reading the following description of the embodiments of the invention, provided solely by way of non-limiting examples and with reference to the drawings disclosed herewith.

### BRIEF DESCRIPTION OF THE DRAWINGS

FIG. 1, which has already been mentioned, illustrates a motor compressor comprising a mechanical system according to the state of the art;

FIG. 2 illustrates a first embodiment of a mechanical system;

FIG. 3 illustrates a second embodiment of the mechanical system;

FIG. 4 illustrates a third embodiment of the mechanical system;

FIG. 5 illustrates a fourth embodiment of the mechanical system;

FIG. 6 illustrates a fifth embodiment of the mechanical system;

FIG. 7 illustrates a sixth embodiment of the mechanical system;

FIG. 8 illustrates a sixth embodiment of a compaction element;

FIG. 9 illustrates a cross sectional view of FIG. 8;

FIG. 10 illustrates a seventh embodiment of the compaction element;

FIG. 11 illustrates a cross sectional view of FIG. 10;

FIG. 12 illustrates an eight embodiment of the compaction element;

FIG. 13 illustrates a cross sectional view of FIG. 12;

FIG. 14 illustrates a ninth embodiment of the compaction element;

FIG. 15 illustrates a cross sectional view of FIG. 14;

FIG. 16 illustrates a ninth embodiment of the mechanical system; and

FIG. 17 illustrates a cross sectional view of FIG. 16.

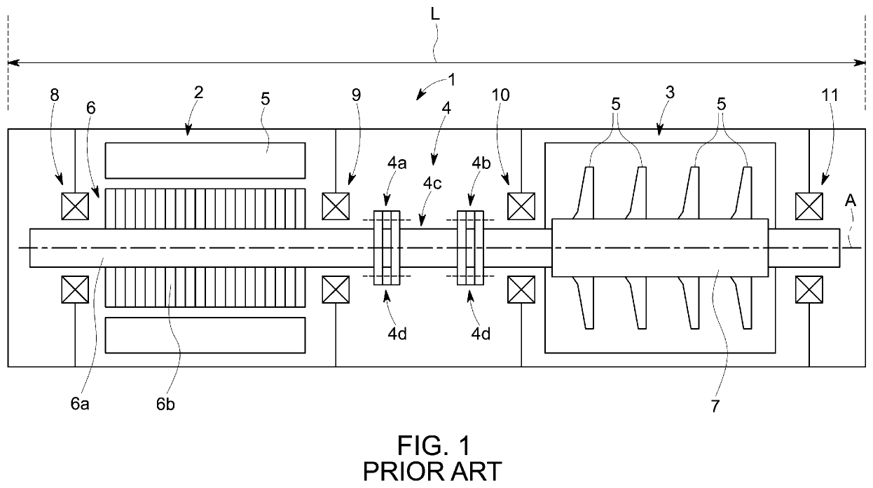

### DETAILED DESCRIPTION

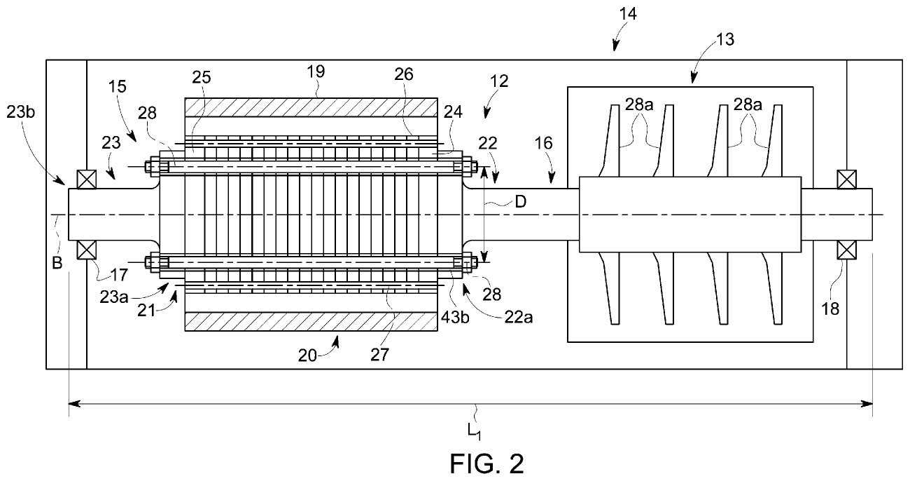

Reference is made to FIG. 2 which illustrates a partial cross section of a mechanical system 12 connected to a compression section 13 of a first embodiment of a motor compressor 14, with the mechanical system 12 being integrated into the motor compressor 14.

The mechanical system 12 comprises a rotor 15 comprising a non-through shaft of central axis B connected directly to a transmission shaft 16 of the compression section 13.

The diameter of the transmission shaft 16 is dimensioned according to the torque value to be transmitted.

The rotor 15 and the transmission shaft 16 are maintained in rotation by two bearings 17 and 18 located respectively at the free end of the rotor 15 and the transmission shaft 16.

The bearings 17 and 18 are for example bearings on oil film, on gas film or with magnetic levitation.

The rotor 15 is inserted into a stator 19 of an asynchronous squirrel cage rotating electric machine 20.

As a variant, the rotating electric machine 20 can be a machine of the wound rotor asynchronous type or synchronous type, preferably with a wound rotor of which the power supply of the rotor is preferably performed via rings and brushes.

The non-through shaft rotor 15 comprises a cylindrical magnetic block 21 enclosed between a first 22 and second 23 raised compaction elements forming a rotor shaft.

One end of the transmission shaft 16 is connected directly to the first compaction element 22.

The first and second compaction elements 23 and 24 have a different structure.

According to a first embodiment, the first compaction element 22 comprises a fixing flange 22a in contact with the magnetic block 21 and integral with the transmission shaft 16.

The fixing flange 22a and the transmission shaft 16 are for example obtained by molding or forging.

According to a second embodiment, the second compaction element 23 comprises a fixing flange 23a in contact with the magnetic block 21 and an end shaft 23b connected to the free surface of the fixing flange 23a.

The magnetic block 21 comprises two short-circuit discs 24 and 25 enclosing compacted magnetic sheets 26 and conductive bars 27 housed in the magnetic sheets 26 and the short-circuit discs 24 and 25 such that the short-circuit discs 24 and 25 and the conductive bars 27 form a squirrel cage.

The magnetic sheets 26 are preferably less than 2 mm thick, for example 0.65 mm or 0.5 mm.

As a variant, the magnetic block 21 comprises a stack of metal plates, the thickness of the metal plates preferably being greater than 5% of the external diameter of the magnetic block 21.

According to yet another variant, the magnetic block 21 comprises a one-piece steel body.

Tie rods 28 are distributed uniformly over a diameter D of the magnetic block 21 so as to keep the magnetic sheets 26 compacted between the compaction elements 22 and 23.

The tie rods 28 pass through smooth holes 43b positioned in the compaction elements 22 and 23 and comprise a nut at each end so as to keep the magnetic sheets 26 compacted.

The compression section 13 comprises compression wheels 28a mounted on the transmission shaft 16 so that the rotor 15 drives in rotation the wheels 28a to compress a gas.

As the rotor 15 has a non-through shaft, the peripheral speed of the rotor 15 is not limited to 200 m/s, enabling the performance of the electric machine 20 to be improved. The higher the rotor 15 rotation speed, the greater the power developed by the rotating electric machine 20.

The mechanical system 12 does not have a flexible coupling device between the rotor shaft and the transmission shaft 16 enabling the bearings which hold the coupling device to be removed.

Removing the flexible coupling device and the bearings which hold the said device enables the overall performance of the mechanical power transmission of the mechanical system 12 to be improved, notably between the rotor 15 and the compression section 13.

In addition, removing the flexible coupling device and the bearings which hold the said device enables the weight of the mechanical system 12 to be reduced and a length L1 along axis B of the mechanical system 12 to be reduced, enabling the critical speed of the mechanical system to be reduced.

More precisely, the mechanical system 12 may run at a hypercritical rotation speed, that is greater than or equal to a multiple of the critical rotation speed, for example at two or three times the critical speed.

As the length L1 of the mechanical system 12 is shorter than that of a mechanical system in the state of the art, the number of critical speeds reduced within the operating speed range facilitates the operation of the mechanical system 12.

For example, the rotor 15 may run at a peripheral speed of 300 m/s, improving by as much the energy performance of the mechanical system 12.

In addition, as the compaction element 22 and the transmission shaft 16 are integral, the maximum torque transmitted by the rotor 15 to the compression section 13 is higher than the maximum torque transmitted by a known mechanical system in the state of the art comprising a flexible device.

According to one embodiment, the mechanical system 12 may be integrated into or coupled to any mechanical device which comprises a transmission shaft.

In a variant which is not shown, the fixing flange 22a comprises threaded holes to accommodate the tie rods 28 and the fixing flange 23a comprises counterbores which accommodate nuts at the other end of the tie rods 28.

According to yet another variant, the fixing flange 22a comprises counterbores which accommodate nuts sunk into the fixing flange and fixed to the threaded end of the tie rods 28.

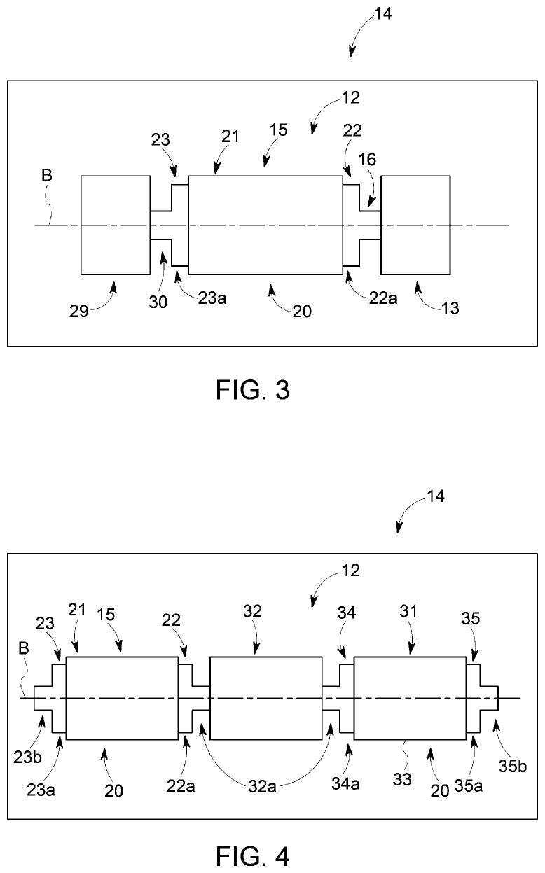

FIG. 3 illustrates a partial cross section of a second embodiment of the mechanical system 12 integrated into a second embodiment of the motor compressor 14.

It shows the rotor 15 comprising the magnetic block 21 enclosed between the first and second compaction elements 22 and 23, with the compression section 13 comprising the transmission shaft 16.

This embodiment differs from the embodiment illustrated in FIG. 2 in that the second compaction element 23 is of an identical structure to the first compaction element 22.

The second compaction element 23 comprises the fixing flange 23a directly connected to a second transmission shaft 30, with the fixing flange 23a and the second transmission shaft 30 being integral.

The second transmission shaft 30 is incorporated into a second compression section 29 identical to the first compression section 13.

The rotating electric machine 20 incorporating the rotor 15 is dimensioned to drive the two compression sections 13 and 29.

Generally, the performance of a rotating electric machine is better for a high-power machine.

As a result, the mechanical system 12 has a better overall performance than a system comprising two rotating electric machines each driving one mechanical device for an identical consumed power.

Furthermore, the use of a single rotating electric machine makes it possible to reduce the overall dimensions and weight of the mechanical system 12.

FIG. 4 illustrates a partial cross section of a third embodiment of the mechanical system 12 integrated into a third embodiment of the motor compressor 14.

It illustrates the rotor 15 comprising the two compaction elements 22 and 23.

This embodiment differs from the first and second embodiments above illustrated in FIGS. 2 and 3 in that it comprises a second rotor 31 with a structure identical to the rotor 15 and a mechanical device 32, with the second rotor 31 being incorporated into a second rotating electric machine (not shown) with an identical architecture to the rotating electric machine 20.

The second rotor 31 comprises a magnetic block 33 with an identical structure to the magnetic block 21 of the rotor 15 enclosed by a first and second compaction elements 35 and 34.

According to another embodiment, the architecture of the second rotating electric machine may be different from the architecture of the rotating electric machine 20.

According to yet another embodiment, the magnetic block 33 of the second rotor 31 may be of a different structure to the magnetic block 21 of the rotor 15.

For example, the magnetic block 33 may comprise thick plates which replace the magnetic sheets.

The first and second compaction elements 23 and 35 of the rotors 15 and 31 are of an identical structure, the second compaction element 23 comprising the fixing flange 23a in contact with the magnetic block 21 and the end shaft 23b connected to the free surface of the fixing flange 23a and the first compaction element 35 comprising a fixing flange 35a in contact with the magnetic block 33 and an end shaft 35b connected to the free surface of the fixing flange 35a.

The diameter of the shafts 23b and 35b may be identical or different.

The mechanical device 32 comprises a transmission shaft 32a.

The first compaction element 22 of the rotor 15 comprises the fixing flange 22a in contact with the magnetic block 21 and integral with a first end of the transmission shaft 32a, and the second compaction element 34 of the rotor 31 comprises a fixing flange 34a in contact with the magnetic block 33 and integral with a second end of the transmission shaft 32a.

According to another embodiment, the compaction elements of the rotors 15 and 31 may be of different structures.

The mechanical system 12 comprising two rotating electric machines connected to the transmission shaft 32a makes it possible to drive the very high power mechanical device 32 which cannot be driven by a single rotating electric machine.

The mechanical system 12 is therefore more compact and has a reduced weight and better overall performance than a system with two mechanical devices, each being coupled to a rotating electric machine.

Thanks to their compact size and the reduction in the number of bearings, the mechanical systems described in FIGS. 3 and 4 enable operation at hypercritical rotation speeds or multiple of critical rotation speeds.

Two rotors 15 and 31 with smaller diameters coupled to the mechanical device 32 enable operation at a peripheral speed higher than 200 m/s, for example at 300 m/s, improving the overall performance of the mechanical system 12.

Additional embodiments for compaction elements 22, 23, 34 and 35 are now detailed.

The compaction elements 22, 23, 34 and 35 comprise one of the structures detailed in the following embodiments, the first and second compaction elements of the same rotor may be of an identical or different structure.

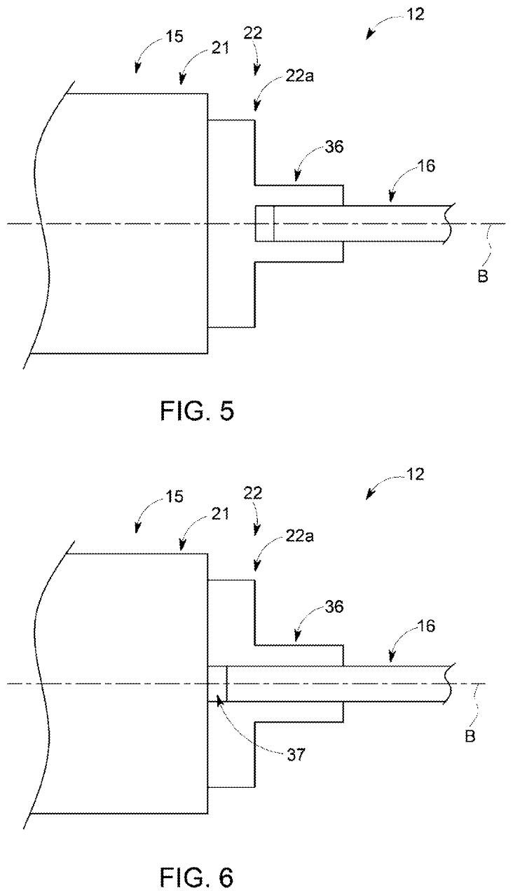

FIG. 5 illustrates a partial view of a fourth embodiment of a mechanical system 12 comprising a third embodiment of the compaction element 22.

It illustrates the rotor 15 comprising the first compaction element 22 and the transmission shaft 16.

The compaction element 22 comprises the fixing flange 22a in contact with the magnetic block 21.

The free end of the compaction element 22 comprises a coupling sleeve 36, with the transmission shaft 16 slotting into the coupling sleeve 36 so that a mechanical torque transits through the transmission shaft 16 and the fixing flange 22a.

The internal and external diameters of the sleeve 36 are dimensioned according to the diameter of the shaft 16.

The transmission shaft 16 is held in the sleeve 36 for example by pinning, shrink-fitting or by screwing in a threaded hole.

According to another embodiment, the shaft 16 may comprise grooves which work with the grooves present around the internal diameter of the sleeve 36.

The rotor 15 comprising the sleeve 36 and the mechanical device comprising the shaft 16 may be produced independently of each other, then assembled with each other.

This enables the mechanical system to be transported in several modules comprising for example a first module comprising the electric machine 20 and a second module comprising the compression section 13.

FIG. 6 illustrates a partial view of a fifth embodiment of the mechanical system 12 comprising a fourth embodiment of the compaction element 22.

This embodiment of the compaction element 22 differs from the third embodiment above illustrated in FIG. 5 in that the fixing flange 22a comprises a central through hole 37 extending in the coupling sleeve 36, defining a fourth embodiment for the compaction element 22.

The third and fourth embodiments for the compaction element 22 enable a smaller end to be produced for the transmission shaft 16, facilitating for example the mounting of the compression wheels 28 by making it possible to mount them by the two ends of the shaft 16.

As a variant, the interior diameter of the sleeve 36 is threaded, conical or polygonal to transmit even more torque.

The third embodiment enables operation at higher rotation speeds than in the fourth embodiment, but transmitting a lower torque than in the fourth embodiment.

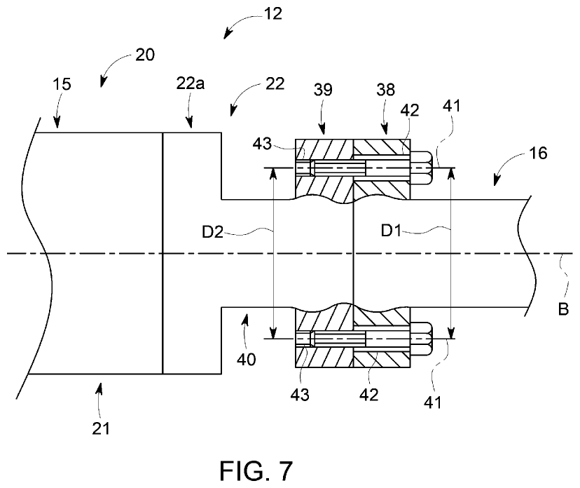

FIG. 7 illustrates a partial cross section of a sixth embodiment of the mechanical system 12 comprising a fifth embodiment of the compaction element 22.

It illustrates the rotor 15 and the transmission shaft 16.

One end of the transmission shaft 16 is comprises a first coupling flange 38.

The compaction element 22 comprises the fixing flange 22a in contact with the magnetic block 21.

The free end of the compaction element 22 comprises a second coupling flange 39, with the first and second coupling flanges 38 and 39 being connected to each other so that a mechanical torque transits through the transmission shaft 16 and the fixing flange 22a.

The fixing flange 22a and the second coupling flange 39 are connected by a median shaft 40.

The coupling flanges are connected to each other for example by screws 41, with each screw 41 passing through an open smooth hole 42 in the first coupling flange 38 and being held in a threaded hole 43 in the second coupling flange 39.

The threaded holes 43 are distributed uniformly over an implantation diameter D2 in the second flange 39 and the open smooth holes 42 are distributed uniformly over an implantation diameter D1 in the first flange 38, with the implantation diameters D1 and D2 of the first and second flanges equal or substantially equal.

According to another embodiment, the compaction element 22 does not have the median shaft 40.

According to yet another embodiment, if the compaction element 22 comprises the median shaft 40, the smooth 42 and threaded 43 holes are inserted respectively into the second and first coupling flanges 39 and 38.

As a variant, the coupling flanges 39 and 38 comprise smooth holes 42 into which coupling bolts are inserted, for example, screws and nuts, or threaded studs, with one nut held on an end of each stud.

The rotor 15 and the transmission shaft 16 may be separated easily by removing the screws 41 and connected easily by tightening the screws 41.

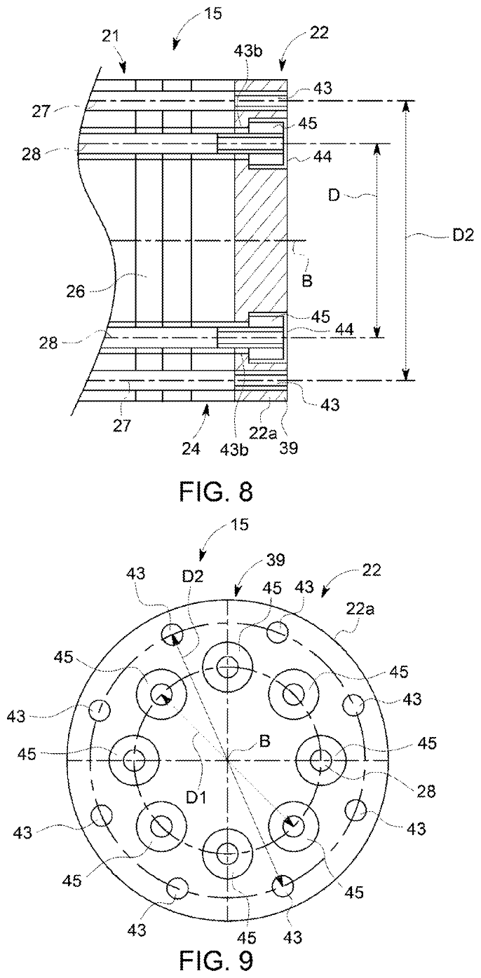

FIGS. 8 and 9 illustrate a partial cross section and a side view of a sixth embodiment of the compaction element 22 comprising a second embodiment of the second coupling flange 39.

It illustrates the rotor 15 comprising the compaction element 22.

This embodiment differs from the embodiment above illustrated in FIG. 7 in that the compaction element 22 does not comprise a median shaft 40 and in that the compaction element 22 comprises counterbores 44 which accommodate nuts 45 which hold the magnetic sheets 26 compacted so that the end of the tie rods 28 in the compaction element 22 is sunk in the said compaction element, with the tie rods passing through the smooth holes 43b inserted into the fixing flange 22a.

The implantation diameter D of the tie rods 28 is smaller than the implantation diameters of the holes 43 and 42 of the first and second flanges 38 and 39.

The fixing flange 22a and the coupling flange 39 form a single part, with the threaded holes 43 made in the fixing flange 22a and distributed uniformly over an implantation diameter D2.

In a variant which is not shown, the holes 43 are distributed uniformly over two different diameters of the fixing flange 22a to transmit more torque to the coupling flange 38 of the shaft 16 provided with two rows of holding screws 41.

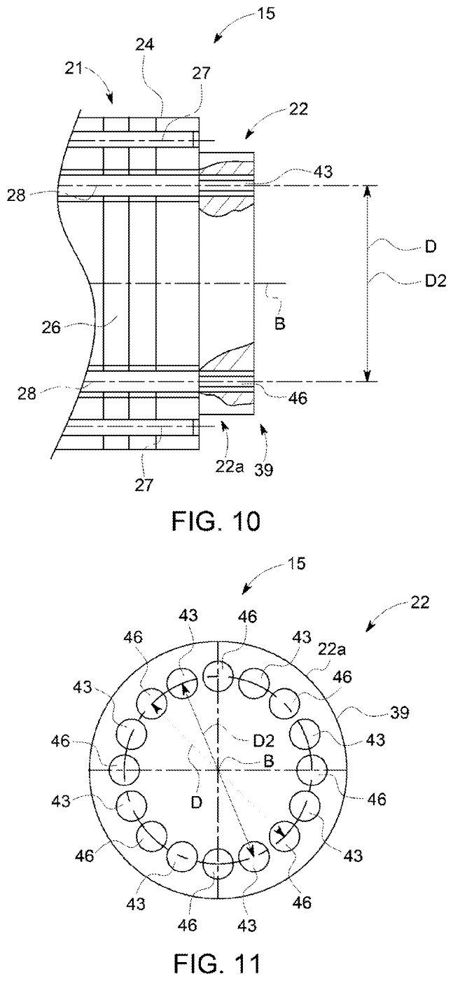

FIGS. 10 and 11 illustrate a partial cross section and a side view of a seventh embodiment of the compaction element 22.

They illustrate the rotor 15 comprising the compaction element 22.

This embodiment differs from the embodiment above illustrated in FIG. 8 in that the implantation diameter D of the tie rods 28 is equal or substantially equal to the implantation diameter D2 of the threaded holes 43 in the second coupling flange 39, with the threaded holes 43 alternating with the implantation holes 46 of the tie rods 28.

The end of the tie rods 28 is held in a threaded hole 46 so that the end of each tie rod 28 is sunk in the compaction element 22.

In a variant which is not shown, the implantation diameter D2 of the threaded holes 43 is greater than the diameter D of the tie rods 28.

According to another variant which is not shown, the threaded holes 43 are placed on two different implantation diameters.

According to yet another variant which is not shown, the implantation diameter D2 of the threaded holes 43 is less than the diameter D of the tie rods 28.

The sixth and seventh embodiments of the compaction element 22 enable the rotor 15 and the mechanical device comprising the transmission shaft 16 to be produced independently of each other, then to be assembled with other, enabling the mechanical system to be transported in several separate modules.

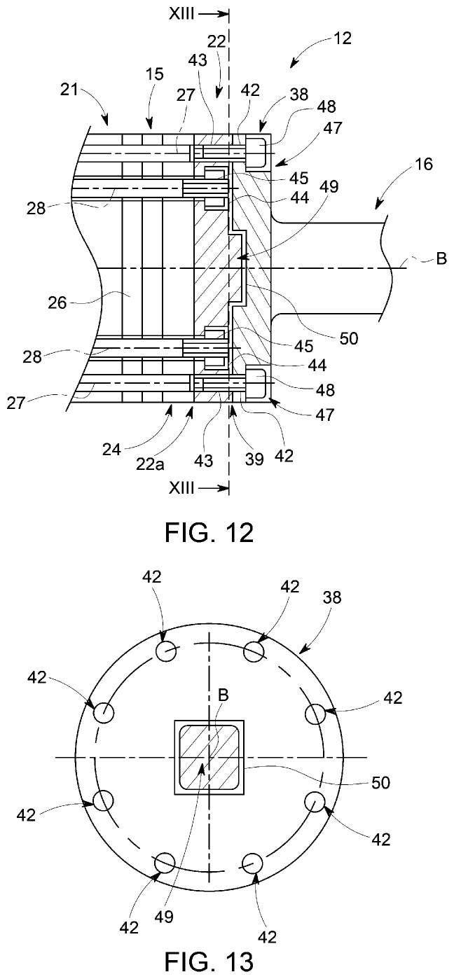

FIGS. 12 and 13 illustrate partial cross sections of a seventh embodiment of the mechanical system 12 comprising an eighth embodiment of the compaction element 22.

They illustrate the rotor 15 comprising the compaction element 22 comprising a third embodiment of the second flange 39 and the transmission shaft 16 comprising a second embodiment of the first flange 38.

In this embodiment of the mechanical system 12, the first flange 38 differs from the first embodiment of the flange 38 illustrated in FIG. 7 in that the first flange 38 comprises counterbores 47 in which are inserted screw heads 48 which connect the first and second flanges 38 and 39 and in that the first flange 38 comprises a central blind hole 50 comprising a central axis aligned or substantially aligned on the axis B.

In addition, in this embodiment, the second flange 39 differs from the second embodiment of the flange 39 illustrated in FIG. 8 in that it comprises a central pin 49 which slots with or without clearance space into the blind hole 50 to transmit a torque between the first and second flanges 38 and 39.

The pin 49 may for example be square, polygonal or triangular.

The pin 49 slotted into the hole 50 enables a higher torque to be transmitted than in the previous embodiments which do not comprise an integral shaft and fixing flange or which do not comprise a pin 49.

As a variant, the pin 49 is non-symmetrical polygonal enabling angular indexation between the flanges 38 and 39.

According to another variant, the pin 49 is cylindrical enabling radial blocking between the flanges 38 and 39.

According to yet another embodiment, the pin 49 is located in the first flange 38 and the blind hole 50 is located in the second flange 39.

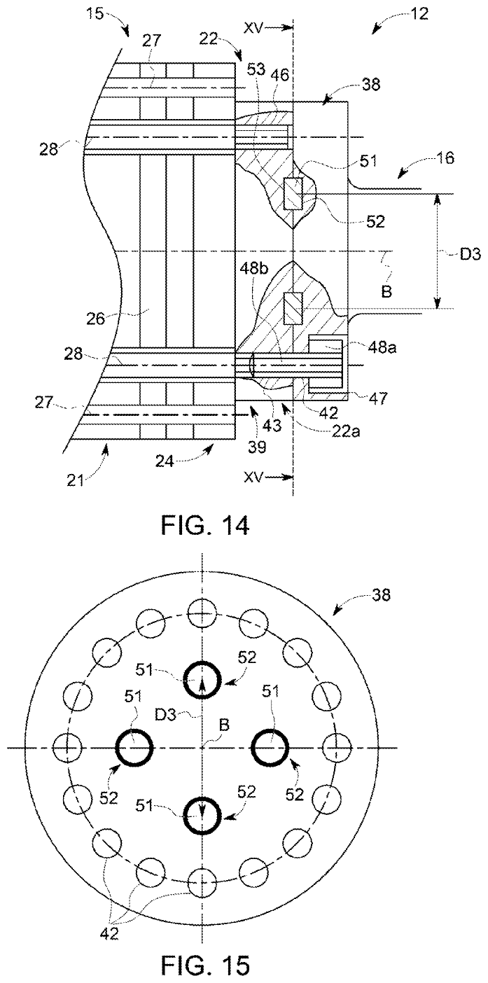

FIGS. 14 and 15 illustrate partial cross sections of an eighth embodiment of the mechanical system 12 comprising a ninth embodiment of the compaction element 22.

They illustrate the rotor 15 comprising the compaction element 22 comprising a fourth embodiment of the second flange 39 and the transmission shaft 16 comprising a third embodiment of the first flange 38 and pins 51.

The pins 51 may have various forms, for example rectangular, polygonal or circular.

In this embodiment, the first flange 38 differs from the first embodiment of the flange 38 illustrated in FIG. 7 in that the first flange 38 comprises counterbores 47 in which are inserted the nuts 48a of the threaded studs 48b connecting the first and second flanges 38 and 39 and in that the first flange 38 comprises central blind holes 52 distributed uniformly over a diameter D3.

In addition, in this embodiment, the second flange 39 differs from the second embodiment of the flange 39 illustrated in FIG. 8 in that it comprises blind holes 53 distributed uniformly over the diameter D3 so that the pins 51 are inserted into the blind holes 52 and 53.

The pins 51 inserted into the blind holes 52 and 53 enable a higher torque to be transmitted than in the embodiments of the mechanical system which comprise neither pins nor an integral shaft and fixing flange.

The flanges 38 and 39 comprise at least two blind holes 52 and 53 each configured to accommodate a pin 51.

In a variant which is not shown, the pins 51 are implanted on two different implantation diameters.

The pins 51 may be inserted with or without a clearance space into the blind holes 52 and 53, bonded or fretted into one or two blind holes 52, 53.

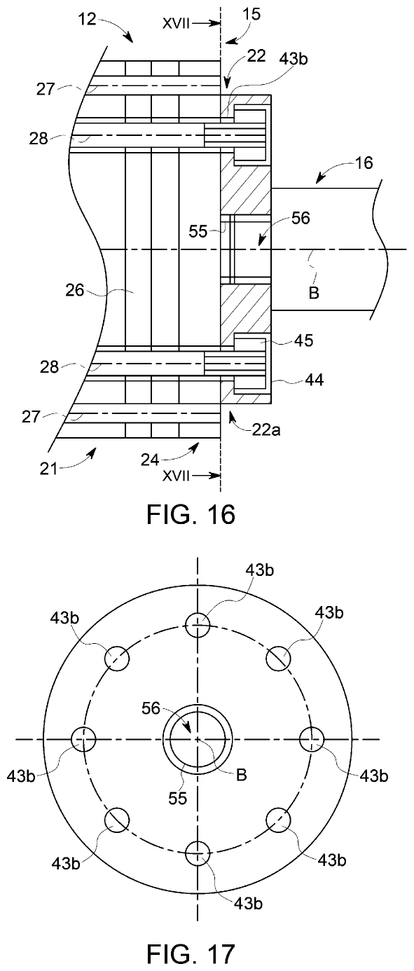

FIGS. 16 and 17 illustrate partial cross sections of a ninth embodiment of the mechanical system 12 comprising a tenth embodiment of the compaction element 22.

They illustrate the rotor 15 comprising the compaction element 22 comprising the fixing flange 22a and the transmission shaft 16.

The fixing flange 22a comprises smooth holes 43b topped with counterbores 44 accommodating the nuts 45 to hold the magnetic sheets 26 compacted and a central open threaded hole 55.

The transmission shaft 16 comprises a threaded central pin 56.

The central pin 56 is held in the central threaded hole 55 so that a mechanical torque transits through the transmission shaft 16 and the fixing flange 22a.

The shaft 16 comprises a shoulder against the fixing flange when the central pin 56 is fully screwed into the central threaded hole 55.

As a variant, the transmission shaft 16 does not comprise a shoulder so that when the threaded end of the shaft 16 is fully screwed into the central threaded hole 55, the end of the shaft 16 is against the magnetic block 21, for example against the short-circuit disc 24.

According to another embodiment, the central hole 55 and the pin 56 do not comprise threading and tapping and are slotted in for example by fretting, pinning or soldering.

According to yet another embodiment, the transmission shaft 16 does not comprise a central pin 56, as the end of the shaft 16 is slotted into the central hole 55.

As a variant, the pin 56 or the end of the shaft 16 is conical, polygonal or comprises grooves in order to transmit more torque.

The embodiments described in FIGS. 5 to 17 enable the rotor 15, the transmission shaft 16 and the mechanical device incorporating the shaft 16 to be produced independently, facilitating logistics and handling in particular.

Of course, in the embodiments described above, the tie rods 28 may be held in a compaction element by a nut sunk into the compaction element or may be held in a thread inserted into a compaction element so that the end of the tie rod does not exceed the compaction element, notably to guarantee the correct contact between the fixing flange and the coupling flange of the shaft 16.

In the embodiments previously disclosed, the rotating electric machines operate in motor mode.

Of course, the rotating electric machines can operate in generator mode to produce electrical power.

In this mode of operation, the mechanical system 12 is driven by a mechanical power producing device, such as for example a gas turbine or a steam turbine, with the shaft or the transmission shafts 16 driving the rotor(s).

According to another mode of operation, a first fixing flange of the rotor 15 may drive a mechanical device consuming mechanical power, for example a compressor, and the second fixing flange of the rotor 15 may be driven by a mechanical device producing mechanical power, for example an electric motor, an internal combustion engine, notably a Diesel engine, a gas turbine or a steam turbine.

Of course, the rotor 15 may comprise identical or different fixing flanges 22a and 23a according to one of the embodiments described in FIGS. 2 to 17.

The embodiments of the mechanical system 12 described above enable in particular the weight and dimensions of the mechanical system to be reduced while increasing the rotation speed of the rotating electric machines incorporated into the system in order to increase the overall performance and power which transit through the said system.

What is claimed is:

1. A mechanical system for rotating electric machine comprising at least one rotor and at least one transmissions shaft for mechanical device, characterized in that the rotor has a non-through shaft and comprises a cylindrical magnetic block enclosed between a first and a second raised compaction elements forming a rotor shaft, with one end of the transmission shaft being connected directly to the first compaction element.

2. The mechanical system of claim 1, further comprising a second transmission shaft for mechanical device, with the second transmission shaft being connected directly to the second compaction element.

3. The mechanical system of claim 1, further comprising a second rotor with non-through shaft, with the second compaction element of the second rotor being connected directly to a second end of the transmission shaft.

4. The mechanical system of claim 1, wherein the first and second compaction elements are of identical structure.

5. The mechanical system of claim 1, wherein the first or the second compaction element comprises a fixing flange in contact with the magnetic block and integral with the first or the second transmission shaft.

6. The mechanical system of claim 1, wherein the first or the second compaction element comprises a fixing flange in contact with the magnetic block, with the free end of the first or second compaction element comprising a coupling sleeve, the first or second shaft slotting into the coupling sleeve so that a mechanical torque transits through one of the transmission shafts and the fixing flange.

7. The mechanical system of claim 1, wherein one end of the first or second transmission shaft comprises a first coupling flange, with the first or second compaction element comprising a fixing flange in contact with the magnetic block, the free end of the first or second compaction element comprising a second coupling flange connected to the coupling flange of the first or second transmission shaft so that a mechanical torque transits through one of the transmission shafts and the fixing flange.

8. The mechanical system of claim 7, further comprising a median shaft connecting the fixing flange and the second coupling flange.

9. The mechanical system of claim 7, further comprising screws, with each screw passing through an open smooth hole of the first coupling flange and held in a threaded hole of the second coupling flange, with the threaded holes distributed uniformly over an implantation diameter (D2) of the second flange and the open smooth holes distributed uniformly over an implantation diameter (D1) of the first flange, the implantation diameters of the holes of the first and second flanges being equal or substantially equal.

10. The mechanical system of claim 9, further comprising tie rods distributed uniformly over a diameter (D) of the magnetic block so as to maintain the magnetic block compacted between the two compaction elements, with the end of the tie rods in the first or second compaction element being sunk in the said compaction element, the implantation diameter (D) of the tie rods being lower than the implantation diameters (D1, D2) of the first and second flanges.

11. The mechanical system of claim 9, further comprising tie rods distributed uniformly over a diameter (D) of the magnetic block so as to maintain the magnetic block compacted between the two compaction elements, with the end of the tie rods in the first or the second compaction element being sunk in the said compaction element, the implantation diameter (D) of the tie rods being equal or substantially equal to the implantation diameters (D1, D2) of the first and second flanges, the threaded holes alternating with the implantation holes of the tie rods.

12. The mechanical system of claim 7, wherein the first flange comprises a central blind hole and the second flange comprises a central pin slotting into the blind hole to transmit a torque between the first and second flanges.

13. The mechanical system of claim 7, wherein the first and second flanges comprise blind holes distributed uniformly over the same diameter (D3), with the system also comprising pins inserted into the blind holes in the first and second flanges to transmit a torque between the first and second flanges.

14. The mechanical system of claim 1, wherein the first or the second compaction element comprises a fixing flange in contact with the magnetic block, with the free end of the first or the second compaction element comprising a central through hole, with one end of the first or second transmission shaft slotting into the through hole so that a mechanical torque transits through one of the shafts and the fixing flange.

15. Motor compressor comprising a mechanical system according to claim 1, a same number of rotating electric machine as rotor and a same number of mechanical device as transmission shaft, with each rotor being inserted into a different electric machine and each transmission shaft being connected to a different mechanical device comprising a compression section.
